(19) United States
(12) Patent Application Publication
(10) Pub. No.: US 2006/0239010 A1
(43) Pub. Date: Oct. 26, 2006

(54) KNOCK SOEN HARDBACK COLLAPSILE LAMPSHADE

(75) Inventor: Hsih Bin Chou, Dong-Guan City (CN)

Correspondence Address: ZITO TLP, 26005 RIDGE ROAD, SUITE 203, DAMASCUS, MD, 20872, US

(73) Assignee: Canel Lighting Co., Ltd.

(21) Appl. No.: 11/111,377

(22) Filed: Apr. 21, 2005

(51) Int. Cl. F21V 1/06

(52) U.S. Cl. 362/352; 362/356; 362/361

(57) ABSTRACT

A lamp shade which can be collapsed to reduce its size for shipping, display and storage, having an upper support, a lower support, and a cover. In one embodiment, the supports are placed into corresponding top and bottom edges of the cover and held in place by press-fitting a plurality of stubs and nubs protruding from the perimeter of the supports into sockets attached along the insides of the top and bottom edges of the cover. The weight of the bottom support pulls the cover of the lampshade into the desired shape when the shade is mounted through a mounting hub in the center of the upper support. In another embodiment, the cover of the lampshade is relatively stiff. In this embodiment, the lampshade is self supporting when assembled, but the cover may still be collapsed when disassembled for shipment or storage.

### RELATED APPLICATIONS

This application is related to U.S. applications Ser. No. 10/615,496 filed Jul. 8, 2003; Ser. No. 10/412,089, filed Apr. 11, 2003; Ser. No. 10/274,699 filed Oct. 18, 2002.

### FIELD OF THE INVENTION

The present invention relates to lampshade frames which are covered with a flexible material and can be collapsed to occupy less space during shipping and storage. More specifically, the present invention is a strut-free, collapsible lampshade with a cover, a removable upper and lower ring, and a mounting spider with a mounting hub for mounting the lampshade on a lamp base.

### BACKGROUND OF THE INVENTION

A significant part of the sales price of a table lamp arises from the cost of transporting the lamp from the manufacturing plant to the retail sales store or to the purchaser and the cost for inventory space, shelf space and storage space. Because the bulky shape of the shade comprises a substantial portion of the lamp's total packaging volume, the assembled shade often disproportionately affects the shipping, display and storage cost and ultimately the sales price of the lamp.

Prior art contains examples of collapsible shades, which depend on the stiffness of a removable frame to hold the shape of the shade after assembly. Prior art frames contain support rings, radial struts and vertical struts. The frame contributes a significant cost to the overall shade and in certain embodiments, it can be quite difficult to assemble. The present invention is designed to trim the ultimate cost of the lampshade by reducing the structural components in the frame. The frame reduction will also simplify the lampshade's assembly.

### SUMMARY OF THE INVENTION

A collapsible lampshade is disclosed having an upper ring and a lower ring, and a flexible cover, such as cloth, fabric or paper removably attached to the upper and lower rings, and a mounting spider assembly spanning the upper ring to facilitate mounting of the lampshade onto a variety of lamps. The rings are removed from the shade to allow the shade to be collapsed.

In an exemplary embodiment, as shown in FIGS. 1, 2, and 3, the a top support comprises a generally circular shaped ring, made of metal, plastic or any other relatively thin, stiff material. A spider-shaped mounting structure comprising multiple legs and a central mounting hub is affixed to the ring at the end of each leg. The legs extend radially from the mounting hub and project just past the of the outer periphery of the top support. The legs are permanently attached to the top support. The portion of the legs which extends beyond the support serve as top cover attachment stubs.

The bottom support is of the same ring construction as the top support, but without a spider-shaped mounting structure. Bottom cover attachment nubs are attached to the outer periphery of the bottom support (in place of the top cover attachment stubs).

The cover comprises a flexible skin which at its top edge stretches circumferentially around the top support. Top attachment sockets are attached to the inside of the top edge of the cover, corresponding to the locations of the top cover attachment stubs. The bottom edge of the cover stretches circumferentially about the bottom support. Bottom attachment sockets are attached to the inside of the bottom edge of the cover, corresponding to the locations of the bottom attachment nubs.

To assemble the shade, the top of the cover is stretched around the top support, aligning the top attachment sockets with the top attachment stubs. The stubs are pressed into the sockets, affixing the top of the cover to the top support. The bottom of the cover is stretched around the bottom support, aligning the bottom attachment sockets with the bottom attachment nubs. The nubs are pressed into the sockets, affixing the bottom of the cover to the bottom support.

The assembled shade is placed on a lamp stand with the mounting hub situated over a suitable mounting appurtenance. The weight of the cover and bottom support stretch the shade to a visually acceptable shape with the top support generally in a plane parallel to the bottom support.

To disassemble the lampshade, the stubs and nubs are pressed out of their respective top and bottom attachment sockets, freeing the cover from the two supports. The cover is collapsed and the three-part shade may be economically packed for shipment or storage.

In an alternate embodiment, the cover of the lampshade is relatively stiff. In the assembled configuration, the stiffness of the cover provides the overall lampshade with enough self-supportiveness to be able to stand alone without collapsing when not mounted on a lamp stand. When disassembled, the cover may still be pressed out of its assembled shape to compress its volume for shipment or storage. The flexible stiffness of the material allows the cover to resume its former shape for re-assembly after shipment or storage.

### BRIEF DESCRIPTION OF THE DRAWINGS

Exemplary embodiments of the invention are discussed hereinafter in reference to the drawings, in which:

FIG. 1 a perspective view of the lampshade of the present invention fully assembled. A portion of the cover is shown cut away to provide clarity to the supporting frame structure.

FIG. 2 is a perspective view of the upper and lower supports of the lampshade of the present invention, disassembled from the cover.

FIG. 3 is a series of detail views of the support-to-cover attachment mechanisms taken from Areas “A” and “B” of FIG. 1 depicting the stub-to-socket (Area “A”) and the nub-to-socket (Area “B”) connections relative to each area.

### DETAILED DESCRIPTION OF PREFERRED EXEMPLARY EMBODIMENTS

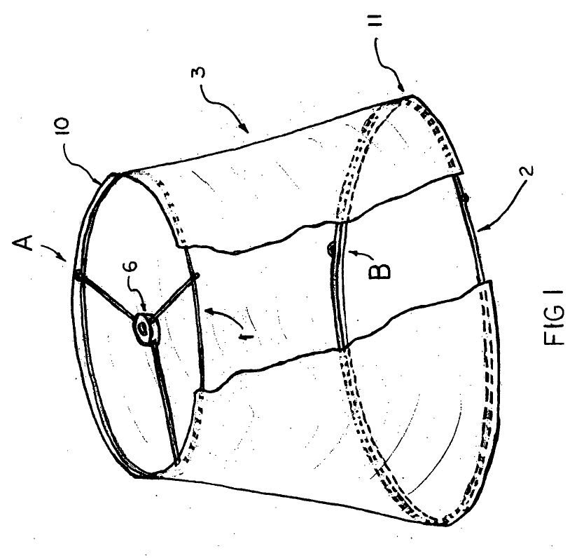

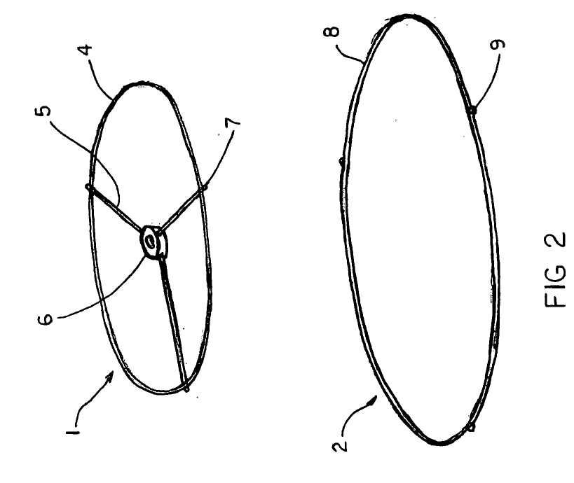

The lampshade of the present invention, as shown assembled in FIG. 1, comprises a top support 1, a bottom support 2 and a_cover 3. FIG. 2 is a view of the top and bottom supports with the cover removed for clarity.

In a first exemplary embodiment, as shown in FIG. 2, top support 1 comprises a top ring 4, struts 5 and a mounting hub 6. Top ring 4 comprises a relatively long rod or bar, of comparatively thin cross-section, formed into a circle. It may be made of metal, plastic or any other relatively stiff material. Struts 5 are also relatively long thin cross-sections of rod or bar. They extend radially between mounting hub 6 at their inner end and top ring 4 at their outer end, with said outer end extending just beyond ring 4. The portion of the outer end that extends beyond ring 4 is referred to as an attachment stub 7. Struts 5 are connected to both mounting hub 6 and top ring 4 where they meet. They may be made from any of the same materials as top ring 4.

Also as shown in FIG. 2, bottom support 2 comprises a bottom ring 8 and attachment nubs 9. Bottom ring 8 is similar in characteristics to top ring 4, but may be of larger diameter, as shown in FIG. 1, or any other diameter (not shown) as suits the lampshade designer. Attachment nubs 9 comprise a three dimensional “dot” of material and are attached to the outer periphery of bottom ring 8, generally in the same plane as the ring. The nubs are again made of similar materials to the rings and struts.

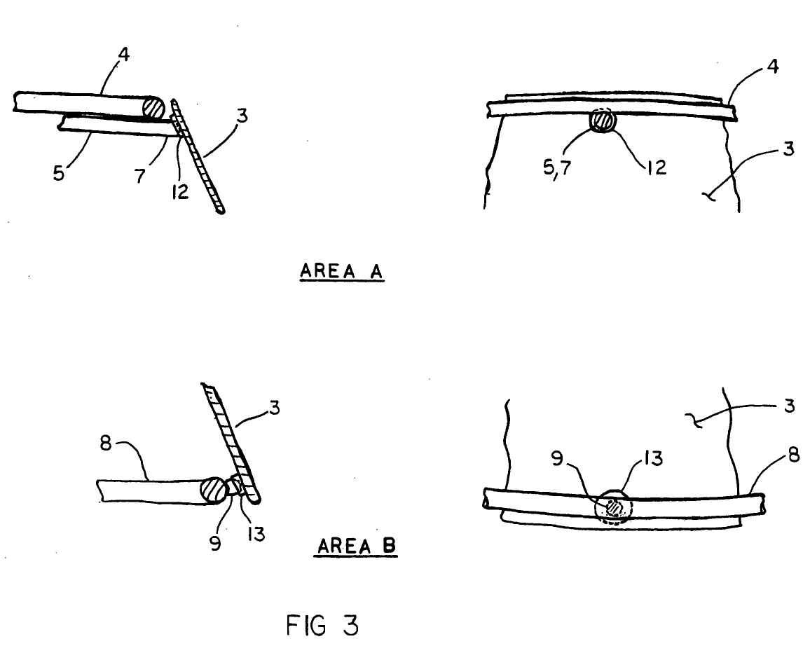

As shown in FIG. 1, cover 3 comprises a generally tubular skin, made from any relatively flexible material, which at its top edge 10 fits relatively tightly around top support 1, and at its bottom edge 11 fits relatively tightly around bottom support 2. Top attachment sockets 12, as shown in Area A of FIGS. 1 and 3, are attached to the inside of the top edge of the cover. They are aligned to correspond to attachment stubs 7 for assembly of the lampshade. Bottom attachment sockets 13, as shown in Area B of FIGS. 1 and 3, are attached to the inside of the bottom edge of the cover. They are aligned to correspond to attachment nubs 9 for assembly of the lampshade.

Top and bottom attachment sockets 12 and 13 are generally short, cylindrical sections of material, attached by bonding or any other suitable manner to the inside of cover 3 as shown in Areas A and B of FIG. 3. They may be made of plastic, metal or any other material suited to the purpose of cradling their respective stubs and nubs during assembly.

Mounting hub 6 comprises a generally doughnut-shaped element having a central hole that is used for mounting the lamp on a common lamp stand. The mounting hub be of any variety common to those familiar with the art of lampshade design and manufacture.

In the exemplary embodiment illustrated above, sets of three struts, attachment stubs and attachment nubs are shown. However, any number may be used without departing from the teachings of the invention.

To assemble the lampshade, top support 1 is first placed into position inside of top edge 10 of cover 3 with attachment stubs 7 aligned with their corresponding top attachment sockets 12. Stubs 7 are pressed into sockets 12, with their installed configuration shown in Area A of FIG. 3. The tightness of the fit between top support 1 and cover 3 holds stubs 7 in place within sockets 12. Next, bottom support 2 is placed into position inside of bottom edge 11 of cover 3 with attachment nubs 9 aligned with their corresponding bottom attachment sockets 13. Nubs 9 are pressed into sockets 13, with their installed configuration shown in Area B of FIG. 3. The tightness of the fit between bottom support 2 and cover 3 holds nubs 9 in place within sockets 13. A completed assembly of the lampshade is depicted in FIG. 1.

Once assembled, the lampshade may be mounted onto a lampshade stand by placing mounting hub 6 over a suitable mounting appendage on the stand as is commonly known in the art (not shown).

To disassemble the lampshade, stubs 7 and nubs 9 are pressed out of their respective sockets along the top and bottom edges of the cover. This frees the top and bottom supports for removal from the top and bottom edges of the cover. The cover may now be collapsed for packaging or storage along with the disassembled top and bottom supports.

In a second embodiment, all aspects of the lampshade are as in the first embodiment with the exception that the cover comprises a relatively stiff material. In the assembled configuration, the lampshade of the second embodiment is self-supporting when resting (not mounted) on bottom edge 11 of cover 3. When in the disassembled configuration of the second embodiment, cover 3 is able to be flexed out of its natural shape (not shown) so as to reduce its overall volume for storage or shipment.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A collapsible lampshade, comprising:
an upper support comprising an upper ring, radial struts having attachment stubs at an outer end and a mounting hub;
a lower support comprising a lower ring and attachment nubs and having a weight;
a flexible cover having a top edge and a bottom edge, each having an inside surface;
a plurality of upper sockets corresponding to said attachment stubs attached to said inside surface of said top edge; and
a plurality of lower sockets corresponding to said attachment nubs attached to said inside surface of said bottom edge;
wherein, to assemble said collapsible lampshade:
said upper support is placed along said inside surface of said top edge and said attachment stubs are pressed into said corresponding upper sockets; and
said lower support is placed along said inside surface of said bottom edge and said attachment nubs are pressed into said corresponding lower sockets.

2. The collapsible lampshade of claim 1, wherein:
said top and bottom edges are of a diametric size, relative to said corresponding upper and lower supports, so as to create tension within said edges when said supports are placed along said inside surfaces, and wherein said tension holds said attachment stubs and attachment nubs in position within said corresponding upper and lower sockets.

3. The collapsible lampshade of claim 1, wherein:
said collapsible lampshade hangs in its intended shape when mounted via said mounting hub with said weight of said bottom support creates tension in said cover between said upper and lower supports.

4. The collapsible lampshade of claim 1, wherein:
said collapsible lampshade collapses when said upper and lower supports are removed from along said inside surfaces of said top and bottom edges of said cover.

5. The collapsible lampshade of claim 1, wherein:
said cover is relatively stiff so as to be self-supporting when said upper and lower supports are placed along said inside surfaces of said top and bottom edges with said attachment stubs and attachment nubs in position within said corresponding upper and lower sockets.
